(19) United States
(12) Patent Application Publication
(10) Pub. No.: US 2026/0347604 A1
(43) Pub. Date: Nov. 5, 2026

(54) BIOPLASTIC MATERIAL AND METHOD

(71) Applicant: Aleksander P. Stec, Fayetteville, GA (US)

(72) Inventor: Aleksander P. Stec, Fayetteville, GA (US)

(21) Appl. No.: 19/197,426

(22) Filed: May 2, 2025

(51) Int. Cl. C08L 71/02; C08K 5/053; C08K 5/1545

(52) U.S. Cl. CPC C08L 71/02; C08K 5/053; C08K 5/1545; C08L 2201/06; C08L 2205/06

(57) ABSTRACT

Disclosed is a bioplastic made from naturally occurring starch, methods of manufacturing the bioplastic and articles made therefrom.

### BACKGROUND

This disclosure relates to bioplastics, products that include such bioplastics, and methods of making and using the same.

More than about 200 billion pounds of petroleum-based plastics are produced annually, which can require more than seven million barrels of petroleum oil daily. Over one billion tons of plastic have been disposed of as waste, the majority of which may require thousands of years to decompose. Additionally, both manufacturing and disposing of plastic products by incineration releases vast quantities of toxins that can be damaging to human-inhabited ecosystems.

Plastic is becoming a major problem in our world. Because of our careless disposal and lack of recycling, the Pacific Ocean now has several different gyres of plastic, commonly known as the North and South Great Pacific Garbage Patch, respectively. Recently scientists have found plastic degrades rapidly in water, but leaves behind microplastics, particles of plastic so small they cannot be seen. This poses a danger as chemicals are leached into the water and plastics are then eaten by marine life, spreading dangerous substances up the food chain.

A primary chemical used in plastic is Bisphenol A (BPA). Already detected in 95% of Americans, BPA has been found to be dangerous in rats, causing birth defects, infertility, tooth enamel breakdown, and even possible multigenerational developmental and behavioral effects. BPA may also cause a lower vitamin D level in humans, which can lead to a higher risk for cancer, arthritis, insomnia, and heart disease. Many products have begun to go “BPA Free”; however, these products instead contain bisphenol AF, F, and S, all chemicals which some preliminary research points to as even more dangerous.

Bioplastics are considered viable alternatives for replacing petroleum-based plastics. Bioplastics are typically derived from renewable raw materials and can contain one or more biopolymeric substances and thus lack harmful substances like BPA. Bioplastics can be used in different settings such as catering products where the perishable plastics can be used to make disposable crockery and cutlery. Biodegradable plastics are further described in “Green Plastics, An Introduction to the New Science of Biodegradable Plastics.” by E. S. Stevens, Princeton University Press (2002) which is incorporated by reference herein in its entirety.

Improvement in the properties of bioplastics, especially in their biocompatibility, biodegradability and long-term environmental impact remains an issue. Thus, new or 1 improved materials and methods such as those described herein are very much needed. The compositions, as well as the methods, described herein are directed toward these needs and other ends.

### BRIEF SUMMARY

This disclosure relates, inter alia, to bioplastics, products that include such bioplastics, and methods of making and using the same.

In one aspect of the invention, the disclosure provides, inter alia, a bioplastic derived from a naturally occurring starch derived from biomass, a polygalactomannan (e.g., guar gum), and one or more plasticizers. Bioplastics, including their blends, can be composed of a matrix, which can include a biopolymer and optionally other additives such as naturally occurring fibers, which can be derived from natural plant fibers. Upon disposal, many bioplastics can safely and naturally biodegrade.

In another aspect, the disclosure describes a process for making a bioplastic including heating a mixture, which includes a polysaccharide obtained from a renewable source, water, a polygalactomannan, one or more plasticizers, and optionally an additive; casting the hot mixture to form a desired structure; and cooling the mixture to provide a bioplastic.

In yet another aspect, the disclosure describes an article including a bioplastic.

One or more of the above aspects of the disclosure can include one or more of the following implementations.

In some implementations, the oligosaccharide is obtained by hydrolysis of a polysaccharide (such as starch, agar or a combination of both) obtained from a renewable source. In some implementations, the hydrolysis of polysaccharide is performed in the presence of an acid. In some implementations, the starch is corn starch or avocado starch, or a combination thereof.

In some implementations, the polygalactomannan is guar gum.

In some implementations, the plasticizer is a low molecular weight polyethylene glycol, glycerol or a combination thereof.

In some implementations, the oligosaccharide is obtained by hydrolysis of corn starch or avocado starch, the polygalactomannan is guar gum, the plasticizer is a combination of glycerol and a low molecular weight polyethylene glycol.

The details of one or more implementations of the disclosure are set forth in the accompanying drawings and the description below. Other features, objects, and advantages of the disclosure will be apparent from the description and drawings, and from the claims.

Additional advantages of the disclosed method and compositions will be set forth in part in the description, which follows, and in part will be understood from the description, or may be learned by practice of the disclosed method and compositions. The advantages of the disclosed method and compositions will be realized and attained by means of the elements and combinations particularly pointed out in the appended claims. It is to be understood that both the foregoing general description and the following detailed description are exemplary and explanatory only and are not restrictive of the invention as claimed.

### DETAILED DESCRIPTION

The disclosed bioplastics and methods may be understood more readily by reference to the following detailed description of particular embodiments and the Examples included therein and to the Figures and their previous and following descriptions.

It is understood that the disclosed method and bioplastic compositions are not limited to the particular methodology, protocols, and reagents described as these may vary. It is also to be understood that the terminology used herein is for the purpose of describing particular embodiments only, and is not intended to limit the scope of the present invention which will be limited only by the appended claims.

As used herein, “bioplastic” refers to a plastic whose components are derived from renewable raw materials. The bioplastic is typically biodegradable, and can be shaped, inter alia, by being formed, molded or extruded into a desired shape. A blend of bioplastic refers to a plastic or a bioplastic composition, which includes at least one bioplastic.

As used herein, “biopolymer” refers to a polymer derived from a natural source, such as a plant or an animal. A biopolymer may also be a combination of such polymers, such as in a mixture or as a copolymer.

It must be noted that as used herein and in the appended claims, the singular forms “a”, “an”, and “the” include plural reference unless the context clearly dictates otherwise. Thus, for example, reference to “a dose” includes a plurality of such doses, reference to “the dose” is a reference to one or more doses and equivalents thereof known to those skilled in the art, and so forth.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated, and considered disclosed, is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Throughout the description and claims of this specification, the word “comprise” and variations of the word, such as “comprising” and “comprises,” means “including but not limited to,” and is not intended to exclude, for example, other additives, components, integers, or steps. In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

Unless defined otherwise, all technical and scientific terms used herein have the same meanings as commonly understood by one of skill in the art to which the disclosed method and compositions belong. Although any methods and materials similar or equivalent to those described herein can be used in the practice or testing of the present method and compositions, the particularly useful methods, devices, and materials are as described. Publications cited herein and the material for which they are cited are hereby specifically incorporated by reference. Nothing herein is to be construed as an admission that the present invention is not entitled to antedate such disclosure by virtue of prior invention. No admission is made that any reference constitutes prior art. The discussion of references states what their authors assert, and applicants reserve the right to challenge the accuracy and pertinence of the cited documents. It will be clearly understood that, although a number of publications are referred to herein, such reference does not constitute an admission that any of these documents forms part of the common general knowledge in the art.

The present disclosure provides, inter alia, a bioplastic including an oligosaccharide derived from a naturally occurring starch, a polygalactomannan, one or more plasticizers, and optionally an additive.

Generally, the oligosaccharide in the bioplastic can be any suitable oligosaccharide, or its ester or ether derivative, that is obtained by hydrolysis of a starch polysaccharide. The oligosaccharide can be used directly in the preparation or it can be generated during the process of preparation of the bioplastic.

Starch is a biodegradable polysaccharide biopolymer composed of D-glucose units (C₆H₁₀O₅)ₙ. It consists of the polymers amylase and amylopectin. Amylose is a straight, flexible, and helical polymer composed of long chains of 1,000-2,000 α-D-glucose units connected by α(1→4) glycosidic linkages. In some implementations, the starch oligosaccharide has amylose from about 5% to about 60%, e.g., from about 10% to about 50%, from about 15% to about 45%, from about 20% to about 40%, from about 25% to about 35%, from about 10% to about 20%, from about 30% to about 40%, or from about 40% to about 50%. In some implementations, the starch has less than about 50% amylose, e.g., less than about 45% amylose, less than about 40% amylose, less than about 35% amylose, less than about 30% amylose, less than about 25% amylose, less than about 20% amylose, less than about 15% amylose, or less than about 10% amylose. In some implementations, the starch has more than about 20% amylose, e.g., more than about 25% amylose, more than about 30% amylose, more than about 35% amylose, more than about 40% amylose, more than about 45% amylose, or more than about 50% amylose. Amylopectin is a large polymer that contains up to about 10⁵ α-D-glucose units and is highly branched through α(1→6) glycosidic linkages.

The starch can be any suitable naturally occurring starch and is desirably a starch that can be obtained from biomass. For example, the starch can be extracted from maize (corn), potato, sweet potato, rice, wheat, banana peel, jackfruit, cassava (tapioca), arrowroot, sugar palm, avocado, papaya, mango, and the like.

In some implementations, the oligosaccharide is obtained by hydrolysis of a corn starch. In some implementations, the oligosaccharide is obtained by hydrolysis of avocado seed starch (e.g., Hass cultivar seed starch). In some implementations, the oligosaccharide is obtained by hydrolysis of avocado seed starch in combination with another naturally occurring starch, e.g., corn starch.

The bioplastic further comprises a polygalactomannan. Polygalactomannans are polysaccharides composed principally of a mannose backbone with galactose side units. Polygalactomannan are usually found in the endosperm of leguminous seeds such as guar, locust bean, honey locust, flame tree, and the like. The polygalactomannans may be used in either their natural form or may be substituted with one or more functional groups (e.g., carboxymethyl group). The polygalactomannans can have a mannose to galactose ratio of ~1:1 (fenugreek gum), ~2:1 (guar gum), ~3:1 (tara gum), ~4:1 (locust bean gum or carob gum), or ~5:1 (cassia gum).

In some implementations, the polygalactomannan has a mannose to galactose ratio of ~2:1, e.g., guar gum. Guar derivatives that are commercially available include, but are not limited to, derivatives such as those containing hydroxyethyl, hydroxypropyl and carboxymethylhydroxypropyl substitutions, and other hydrophobic derivatives. Other guar derivatives used with embodiments of the present invention include cationic and anionic guar gums.

The bioplastic further comprises one or more plasticizers. As used herein, “plasticizer” refers to materials, including compounds, capable of plasticizing or softening a biopolymer structure by reducing the intermolecular forces and increasing the intermolecular mobility of the polymer. Plasticizers can also reduce the viscosity of a biopolymer during its preparation. Examples of suitable plasticizers include low molecular weight polymers, oligomers, copolymers, small organic molecules, low molecular weight polyols, glycol ethers, polypropylene glycol, low molecular weight polyethylene glycol, citrate ester type plasticizers, triacetin, propylene glycol, sugar alcohols, glycerin, urea, urea derivatives and mixtures thereof. For example, the plasticizer can be ethylene glycol, propylene glycol, glycerol, 1,2-butylene glycol, 2,3-butylene glycol, styrene glycol, diethylene triethylene glycol, tetraethylene glycol, hexane triol, mannitol, sorbitol, monopropylene glycol monoisopropyl ether, propylene glycol monoethyl ether, ethylene glycol monoethyl ether, diethylene glycol monoethyl ether, sorbitol lactate, ethyl lactate, butyl lactate, ethyl glycolate, dibutylsebacate, acetyltributylcitrate, triethyl citrate, acetyl triethyl citrate, tributyl citrate allyl glycolate, low molecular weight polyethylene glycol, or a mixture thereof.

In some implementations, the plasticizer is selected from the group consisting of glycerol, polyethylene glycols, polyethers, polyols, ureas, sorbitol, and combinations thereof. In some implementations, the plasticizer is selected from glycerol, polyethylene glycols, and combinations thereof.

In some implementations, the plasticizer is selected from glycerol and a low molecular weight polyethylene glycol having a molecular weight in the range of from about 100 g/mol to about 700 g/mol, e.g., PEG 400. In yet other implementations, the plasticizer is a combination of glycerol and a low molecular weight polyethylene glycol having a molecular weight in the range of from about 100 g/mol to about 700 g/mol, e.g., PEG 400.

Although not required, acids optionally can be added to aid in the hydrolysis of the naturally occurring starch. Suitable acids can include carboxylic acids, organophosphoric acids, organosulfonic acids, and organoboric acids. Examples of carboxylic acids include formic acid, acetic acid, propionic acid, oxalic acid, malonic acid, succinic acid, glutaric acid, adipic acid, maleic acid, malic acid, oleic acid, salicylic acid, gallic acid, citric acid, lactic acid, tartaric acid (e.g., dextro-tartaric acid, mesotartaric acid, etc.), glycolic acid, trifluoroacetic acid, benzoic acid, 4-hydroxybenzoic acid, aminobenzoic acid, and p-toluenesulfonic acid. Phenols, such as pyrogallol (benzene-1,2,3-triol) and catechol (benzenediol) can also be used as acids. Anhydrides (e.g., acetic anhydride, succinic anhydride, trifluoroacetic anhydride) may also be employed.

In some embodiments, acids are not included in the bioplastics.

Additives can optionally be added to further increase the mechanical properties of bioplastics. These additives can function as reinforcing agents that make the biopolymer chains more regular. The increase in the alignment of the biopolymer chains can result in a better structure and also in improved mechanical properties. Additives may be derived e.g., from coconut, eggs, clams, wood, pulp, paper, sawdust, collagen, or gelatin. Examples of additives include powered clamshell, powdered eggshell, powdered coconut shell, gelatin, and sawdust. Additives can be derived from natural renewable sources and can be further processed to change their particle size and form. In some implementations, the bioplastic includes from about 1% to about 5% of the additive, from about 5% to about 10% of the additive, from about 10% to about 15% of the additive, or from about 15% to about 20% of the additive. In some implementations, the bioplastic includes about 0.5% of the additive, e.g., about 1% of the additive, about 2% of the additive, about 3% of the additive, about 4% of the additive, about 5% of the additive, or about 6% of the additive.

### Methods of Manufacturing Bioplastics

The present disclosure further provides, inter alia, methods of manufacturing a bioplastic including an oligosaccharide derived from a naturally occurring starch, polygalactomannan, one or more plasticizers, and optionally an additive.

A bioplastic composition can be prepared by a method comprising forming a mixture comprising a naturally occurring starch, polygalactomannan powder, at least one plasticizer, optionally an additive in a solvent such as water. Alternately, the above components can be premixed without the addition of water and stored such that the mixture can be heated together with water just before processing. The combined components can be heated with stirring to make a homogeneous mixture and the heating is continued with stirring until it forms a plastic. In some embodiments, two or more plasticizers are combined to form a first mixture and then the naturally occurring starch and water are added to plasticizer mix. Any type of blending device can be used, in some implementations, a cooking stove, a microwave oven such as a domestic microwave, or a hot plate with a mechanical stirrer is used. The resulting plastic is then removed from the solvent mixture.

Depending on the desired shape and application of the bioplastic, the plastic melt can be processed upon removal. Examples of processing include molding, blowing, flat die extruding, and casting. In some implementations, the plastic melt can be cast only a flat surface lined with a wax paper or plastic wrap. In some implementations, the plastic melt can be poured into a shaped mold lined with a wax paper.

The plastic sample can be dried under ambient condition or under conditions of low humidity such as in a desiccator. In some implementations, the plastic sample is heated. In some implementations, the plastic is heated in a conventional oven for about 2 hours to about 24 hours, about 5 hours to about 20 hours, about 8 hours to about 16 hours, or about 14 hours, at a temperature ranging from about 35 °C to about 65 °C, or about 40 °C to about 60 °C.

Thus, the present disclosure provides a method of manufacturing a bioplastic, the method comprising: (a) forming a mixture comprising a starch selected from the group consisting of corn starch, avocado starch, and combinations thereof, guar gum powder, at least one plasticizer, optionally an additive and water, (b) heating the mixture to boiling while stirring until it forms a plastic, and (c) removing the plastic from the mixture and heating it in an oven for about 4 hours to about 24 hours (preferably 16 hours) (preferably 8 hours to about 20 hours, more preferably about 10 hours to about 18 hours) at a temperature ranging from about 40 °C to about 50 °C.

In some implementations, the amount of water is about 80-90%, the amount of the polygalactomannan (e.g., guar gum) is about 0.1% to about 2%, the amount of the one or more plasticizers is about 1-10% (e.g., the plasticizer can comprise, consist essentially of, or consist of a low molecular weight polyethylene glycol having a molecular weight in the range of from about 100 g/mol to about 700 g/mol present and glycerol present in about 0.1-3% and about 5-10%, respectively), and the amount of starch (e.g., corn starch or avocado starch) is about 5-10%, based on the total weight of the mixture. In other implementations, the amount of water is about 75-90%, the amount of polygalactomannan is about 0.3-0.5%, the amount of plasticizers is about 5-12% (e.g., the amount of polyethylene glycol is about 1-1.5%, the amount of glycerol is about 7-8.5%), and the amount of starch (e.g., corn starch or avocado starch) is about 2-5%, based on the total weight of the mixture.

The present disclosure further provides, inter alia, articles made from the bioplastic of the invention. The bioplastics described in the disclosure can be molded into shapes and designs as desired in a particular application, such as shopping bags, garbage bags/compost bags, trash bin liners, single-use disposable packaging materials, or agricultural products, e.g., pots, mulches, or mulch films.

The bioplastics described in this disclosure can contain smaller amounts of other ingredients without hindering the desired properties of the bioplastic. Examples of such ingredients include dispersion aids, melt stabilizers, processing stabilizers, heat stabilizers, light stabilizers, antioxidants, heat aging stabilizers, whitening agents, anti-blocking agents, bonding agents, and lubricants.

In some implementations, it is desirable that the bioplastic is biodegradable. For example, in some implementations, the bioplastic decomposes within 6 months or less, or 3 months or less, 2 months or less, 30 days or less, or 15 days or less at a temperature of 60 °C or less under typical aerobic composting conditions.

In other implementations, it is desirable that the bioplastic is at least partially transparent, e.g., permits light to pass through it. For example, in some implementations, the bioplastic transmits at least 30%, at least 40%, at least 50%, at least 60%, at least 70%, at least 80%, at least 90% or at least 95% of light, e.g., light at different wavelengths including 280 nm, 350 nm, 400 nm, 500 nm, 600 nm, 700 nm, or 800 nm.

All publications, patent applications, patents, and other references mentioned herein are hereby incorporated by reference herein in their entirety.

It is to be further appreciated that certain features of the disclosure, which are, for clarity, described in the context of separate embodiments, can also be provided in combination in a single embodiment. Conversely, various features of the disclosure that are, for brevity, described in the context of a single embodiment, can also be provided separately or in any suitable sub-combination.

The following examples are included to illustrate the invention, but the invention should not be understood to be limited to these exemplified embodiments.

### Example 1

This example describes the preparation of a bioplastic using corn starch.

Corn starch (Argo brand, 3.72 g, 4%), glycerol (7.16 g, 8.3%), polyethylene glycol 400 (1.22 g 1.3%), guar gum powder (0.36 g, 0.4%) and tap water (78.85 g, 86.4%) (total weight 91.31 g) were combined in a pan and stirred until a homogeneous mixture was formed. The mixture was heated on a hot plate at a low setting (about 90 °C) and stirring continued until the mixture thickened into a viscous gel-like mixture. Once the mixture was vigorously bubbling, the heat was shut off and the mixture was poured onto a sheet of plastic wrap and allowed to cool under ambient conditions (temperatures ranging from 20-22 °C and humidity ranging from 47% to 53%). The resulting sample had a gelatin-like consistency. Once cooled, the sample was placed into a conventional heating oven and heated to a temperature of about 38-55 °C for 24 hours. After evaporation of water, the resulting plastic was found to be translucent and stretchy.

Three to four layers (each approximately 1 mm thick) of the corn starch bioplastic were layered on top of each other and evaluated for their elastic strength. The corn starch bioplastic when layered showed a noticeable increase in strength relative to individual layers.

### Example 2

This example describes the preparation of a bioplastic using avocado starch.

Avocado starch was extracted from avocado seeds as follows: Avocado seeds were skinned, chopped into quarters, and blended with water until the seeds were fully liquefied. The resulting mixture was allowed to sit for 24 hours and then was strained through cheesecloth. The liquid that passed through the cheesecloth was collected in a large beaker. The mixture in the cheesecloth was squeezed to extract all liquid. The starch mixture was allowed to settle and the liquid was removed using a large pipette. The resulting starch mixture was stored in the beaker until ready for use.

The avocado starch (2.42 g), glycerol (7.42 g), polyethylene glycol 400 (1.41 g), guar gum powder (0.48 g) and water (82.50 g) were combined in a pan and stirred until a homogeneous mixture was formed. The mixture was heated on a hot plate at a low setting (about 90 °C) and stirring continued until the mixture thickened into a viscous gel-like mixture. Once the mixture was vigorously bubbling, the heat was shut off and the mixture was poured onto a sheet of plastic wrap and allowed to cool under ambient conditions (temperatures ranging from 20-22 °C and humidity ranging from 47% to 53%). The resulting sample had a gelatin-like consistency. Once cooled, the sample was placed into a conventional heating oven and heated to a temperature of about 38-55 °C for 24 hours. After evaporation of water, the resulting plastic was found to be translucent and stretchy.

Three to four layers (each less than 1 mm thick) of the avocado starch bioplastic were layered on top of each other and evaluated for their elastic strength. The avocado starch bioplastic when layered was still very thin and did not show a noticeable increase in strength relative to individual layers.

### Example 3

This example describes evaluation of the environmental impact of the bioplastics prepared in Examples 1 and 2 upon exposure to water and UV light.

Aquatic tanks (5 gallon) were filled completely with tap water. Two samples (~5 grams) each of the corn starch (Corn 1 and Corn 2) and of the avocado starch (Avocado 1 and Avocado 2) bioplastics prepared according to the method described in Examples 1 and 2, respectively, were placed into the water in separate tanks and the tanks were enclosed under a UV lamp. Additional water tanks containing only tap water (Control 1 and Control 2) or containing polyethylene terephthalate (PET) plastic films (PET 1 and PET 2) (~3 grams each) were also assembled and enclosed under a UV lamp.

The bioplastic and PET plastic samples were periodically examined visually to assess the degree of decomposition. Each water tank contained probes measuring pH, temperature and oxygen levels and measurements were taken once per day for 7 days. After 7 days, a water sample from each tank was analyzed at room temperature for turbidity (PASCO PASPORT PS-2122 Turbidity Sensor) and for light transmittance (PASCO PS 2600 Wireless Spectrometer).

Table 1 below summarizes turbidity measurements (PS-2122 Turbidity Sensor) for each of the samples. Measurement values are reported in Nephelometric Turbidity Units (NTU). Positive NTU values reflect the presence of suspended particulate matter.

TABLE 1
Turbidity Measurements

| Sample | Turbidity (NTU) |
|---|---|
| Control Sample 1 | 1.1 |
| Control Sample 2 | 0 |
| Corn Starch Bioplastic 1 | 0 |
| Corn Starch Bioplastic 2 | 4.1 |
| Avocado Starch Bioplastic 1 | 0 |
| Avocado Starch Bioplastic 2 | 0 |
| PET Sample 1 | 0 |
| PET Sample 2 | 0 |

The turbidity values for each group were in general very low. The values in all tanks were zero except for Control Sample 1, which had a value of 1.1 NTU and Corn Starch Bioplastic 2, which had a value of 4.1 NTU. These results show that the corn and avocado-based bioplastics undergo rapid decomposition in water and release organic matter faster than the test ecosystem can immediately handle. This suggests that the corn and avocado-based bioplastics have a great short-term impact on the environment. It is believed that the high turbidity value for Corn Starch Bioplastic 2 was due to the fact that decomposition of the bioplastic had just begun at the time of sample collection, as particles of the plastic were visible in the water.

Table 2 below summarizes light transmission testing obtained by UV-vis spectrometer (Pasco Spectrometer PS-2600) are shown in the table below for the wavelengths 550-850 nm.

TABLE 2
Bioplastic Light Transmittance

| Sample | % Light Transmittance (median) |
|---|---|
| Control Sample 1 | 100% |
| Control Sample 2 | 100% |
| Corn Starch Bioplastic 1 | 94.83% |
| Corn Starch Bioplastic 2 | 85.47% |
| Avocado Starch Bioplastic 1 | 100% |
| Avocado Starch Bioplastic 2 | 100% |
| PET Sample 1 | 100% |
| PET Sample 2 | 93.91% |

Individual graph analysis shows that the two corn starch-based bioplastics (Corn Starch Bioplastic 1 and 2) had large fluctuations with a median transmittance of 94.831% and 85.466%, respectively. The PET chambers (PET Sample 1 and 2) had transmittance medians of 100% and 93.911% respectively. This indicates that the corn starch bioplastic chamber had more particulates in the water than the PET chambers. This is likely caused by decomposition of the corn starch based bioplastics observed at the time of the water sample collection. The PET sample chambers saw high levels of water clarity, and showed no evidence of decomposition. The avocado starch chambers (Avocado Starch Bioplastic 1 and 2) also had a water clarity of 100%, which indicates there were no particulate remnants, although the avocado starch plastics had totally dissolved at the time of the measurement.

### Example 4

This example describes evaluation of the environmental impact of the bioplastics prepared in Examples 1 and 2 on the rate of plant growth.

Samples of the corn and avocado starch-based bioplastics, as well as samples of PET plastic, were placed in soil next to radish seeds (one seed per growth pod, each tray contained 40 growth pods each) in order to evaluate the effect of the corn starch and avocado-based bioplastic samples on radish plant growth. A control tray was also prepared having no plastic added to the soil and radish seed. The trays containing the radish seeds and plastic samples, as described, were exposed to a 6400K full-spectrum T-5 54 watt bulb for 24 hours a day and watered twice a day, at ~8 AM and at ~3 pm, for 14 days via a spray bottle until the soil was moist (approximately 3-7 mL of water per day). After 14 days, all of the avocado starch plastic was observed to have decomposed while the corn starch plastic was observed to be in the process of decomposing.

Table 3 below summarizes the median radish plant weight after 14 days for each sample system. The median plant weights were calculated after excluding the wilted plants and failed germinations from the data sets.

TABLE 3
Radish Plant Weight

| | N (# | Median | |
|---|---|---|---|
| Sample | plants) | Weight (g) | Observations |
| Corn Starch Bioplastic | 39 | 0.275 | 1 failed germination |
| Control (no plastic) | 38 | 0.295 | 2 failed germinations |
| PET Plastic | 35 | 0.300 | 2 failed germinations; |
| | | | 3 wilted plants |
| Avocado Starch Bioplastic | 26 | 0.355 | 4 failed germinations; |
| | | | 10 wilted plants |

The corn starch bioplastic had the lowest radish plant median weight. The PET plastic median weight was comparable to the PET plastic median weight. The avocado starch bioplastic produced the highest median weight. These results show that the avocado starch plastic had a positive impact on plant growth during the timeframe of the experiment and suggest that upon decomposition the avocado starch plastic acted as a fertilizer for the radish plants. The large number of wilted plants for the avocado starch bioplastic appears to have been due to a higher degree of moisture in the soil, despite these plants having received the same amount of water as the control and other plastic samples

### Example 5

This example describes the impact of the presence of acid (lemon juice or vinegar) on the elastic properties of the corn starch bioplastic.

Sample A1: Corn starch (Argo brand, 4.1 g, 4.23%), glycerol (8.6 g, 8.88%), polyethylene glycol 400 (1.8 g 1.86%), guar gum powder (0.4 g, 0.41%) and tap water (82 g, 84.62%) (total weight 96.9 g) were combined in a pan and stirred until a homogeneous mixture was formed. The resulting mixture was heated on a hot plate while stirring, poured onto a sheet, allowed to cool following the method described in Example 1 and then heated in a conventional heating oven and heated to a temperature of about 65 °C for 3 hours.

Sample A2: Corn starch (Argo brand, 4.3 g, 4.25%), glycerol (8.6 g, 8.51%), polyethylene glycol 400 (1.8 g 1.78%), guar gum powder (0.5 g, 0.49%) and tap water (85.9 g, 84.97%) (total weight 101.1 g) were combined in a pan and stirred until a homogeneous mixture was formed. The resulting mixture was heated on a hot plate while stirring, poured onto a sheet, allowed to cool following the method described in Example 1 and then heated in a conventional heating oven and heated to a temperature of about 65 °C for 3 hours.

Sample B1: Corn starch (Argo brand, 4.3 g, 4.20%), glycerol (8.4 g, 8.2%), polyethylene glycol 400 (1.8 g 1.76%), guar gum powder (0.7 g, 0.68%), lemon juice (citric acid) (0.5 g, 0.49%) and tap water (86.7 g, 84.67%) (total weight 102.4 g) were combined in a pan and stirred until a homogeneous mixture was formed. The resulting mixture was heated on a hot plate while stirring, poured onto a sheet, allowed to cool following the method described in Example 1 and then heated in a conventional heating oven and heated to a temperature of about 65 °C for 3 hours.

Sample B2: Corn starch (Argo brand, 4.1 g, 3.82%), glycerol (10.1 g, 9.4%), polyethylene glycol 400 (2.1 g 1.96%), guar gum powder (0.5 g, 0.47%), lemon juice (citric acid) (0.6 g, 0.56%) and tap water (90 g, 83.8%) (total weight 107.4 g) were combined in a pan and stirred until a homogeneous mixture was formed. The resulting mixture was heated on a hot plate while stirring, poured onto a sheet, allowed to cool following the method described in Example 1 and then heated in a conventional heating oven and heated to a temperature of about 65 °C for 3 hours.

Sample C1: Corn starch (Argo brand, 4.2 g, 3.73%), glycerol (8.8 g, 7.82%), polyethylene glycol 400 (1.9 g 1.69%), guar gum powder (0.5 g, 0.44%), white vinegar (acetic acid) (1.5 g, 01.35%) and tap water (95.7 g, 84.99%) (total weight 112.6 g) were combined in a pan and stirred until a homogeneous mixture was formed. The resulting mixture was heated on a hot plate while stirring, poured onto a sheet, allowed to cool following the method described in Example 1 and then heated in a conventional heating oven and heated to a temperature of about 65 °C for 3 hours.

Sample C2: Corn starch (Argo brand, 4.2 g, 4.15%), glycerol (9.2 g, 9.08%), polyethylene glycol 400 (1.6 g 1.58%), guar gum powder (0.4 g, 0.39%), white vinegar (acetic acid) (1.9 g, 01.91%) and tap water (84 g, 82.92%) (total weight 101.3 g) were combined in a pan and stirred until a homogeneous mixture was formed. The resulting mixture was heated on a hot plate while stirring, poured onto a sheet, allowed to cool following the method described in Example 1 and then heated in a conventional heating oven and heated to a temperature of about 65 °C for 3 hours.

Samples A, B and C were evaluated for tensile strength. A plot of peak stress (N) versus percent elongation shows that Sample A reached 24% elongation before deviation from linearity, whereas Sample B (lemon juice) showed deviation beginning at 22% elongation and Sample C (vinegar) showed deviation beginning at 17% elongation. These results suggest that the presence of acid (lemon juice as in Sample B or vinegar as in Sample C) reduces the elastic strength of the corn starch bioplastic.

I claim:

1. A bioplastic comprising an oligosaccharide obtained by hydrolysis of a starch selected from the group consisting of corn starch, avocado starch, and combinations thereof, a polygalactomannan, at least one plasticizer, and optionally an additive.

2. The bioplastic of claim 1, wherein the plasticizer is selected from the group consisting of glycerol, polyethylene glycols, polyethers, polyols, ureas, sorbitol, and combinations thereof.

3. The bioplastic of claim 1, wherein the polygalactomannan is guar gum.

4. The bioplastic of claim 1, wherein the plasticizer comprises a polyethylene glycol or glycerol.

5. The bioplastic of claim 4, wherein the polyethylene glycol is a low molecular weight polyethylene glycol having a molecular weight in the range of from about 100 g/mol to about 700 g/mol.

6. The bioplastic of claim 1, wherein the plasticizer comprises a polyethylene glycol and glycerol.

7. The bioplastic of claim 6, wherein the polyethylene glycol is PEG 400.

8. The bioplastic of claim 1, wherein the bioplastic comprises about 20-35 wt. % oligosaccharide derived from starch, about 1-10 wt. % polygalactomannan, and about 55-85 wt. % plasticizer.

9. The bioplastic of claim 1, wherein the bioplastic further comprises an additive selected from the group consisting of powdered eggshell, sawdust, powdered coconut shell, gelatin and combinations thereof.

10. A bioplastic consisting essentially of 20-35 wt. % oligosaccharide obtained by hydrolysis of corn starch or avocado starch, 1-10 wt. % guar gum, and 55-85 wt. % plasticizer consisting of a combination of glycerol and a low molecular weight polyethylene glycol having a molecular weight in the range of from about 100 g/mol to about 700 g/mol.

11. A method of manufacturing a bioplastic, the method comprising:
a. Forming a mixture comprising a starch selected from the group consisting of corn starch, avocado starch, and combinations thereof, guar gum powder, at least one plasticizer, optionally an additive and water,
b. Heating the mixture to boiling while stirring until it forms a plastic,
c. Removing the plastic from the mixture and heating it in an oven for about 4 hours to about 24 hours (preferably 16 hours) (preferably 8 hours to about 20 hours, more preferably about 10 hours to about 18 hours) at a temperature ranging from about 40 °C to about 50 °C.

12. The method of claim 11, wherein the amount of water is about 80-90%, the amount of polyethylene glycol is about 0.1-3%, the amount of guar gum is about 0.1% to about 2%, and the amount of glycerol is about 5-10%, and the amount of starch is about 1-10%, based on the total weight of the mixture.

13. The method of claim 11, wherein the amount of water is about 85-90%, the amount of polyethylene glycol is about 1-1.5%, the amount of guar gum is about 0.3-0.5%, the amount of glycerol is about 7-8.5%, and the amount of starch is about 2-5%, based on the total weight of the mixture.

14. The method of claim 11, wherein the polyethylene glycol is a low molecular weight polyethylene glycol having a molecular weight in the range of from about 100 g/mol to about 700 g/mol.

15. The method of claim 11, wherein the starch is avocado starch.

16. The method of claim 11, wherein the plastic is heated from about 10 to about 18 hours.

17. A bioplastic manufactured according to the method of claim 11.

18. The bioplastic of claim 1, wherein the bioplastic decomposes within 30 days or less at a temperature of 50 °C or less.

19. The bioplastic of claim 1, wherein the bioplastic transmits at least 95% light.
